(19) United States
(12) Patent Application Publication
(10) Pub. No.: US 2005/0103911 A1
(43) Pub. Date: May 19, 2005

(54) Spinning reel with clicking bail arm

(76) Inventor: Chi Shing Li, Hong Kong (HK)

Correspondence Address: BLACK LOWE & GRAHAM PLLC;Suite 4800, 701 Fifth Avenue, Seattle, WA, 98104, US

(21) Appl. No.: 10/712,123

(22) Filed: Nov. 13, 2003

(51) Int. Cl. A01K 89/01

(52) U.S. Cl. 242/231

(57) ABSTRACT

A bail securing apparatus secures a position of a bail. A plunger includes a first end and a second end. The first end applies a securing force against a bail support arm supporting a first end of the bail. The first end of the plunger is slidably coupled with the second end by a compressible element forcing the first and second end apart. A plunger mount swivelably receives the second end. An elongated opening in the bail support arm receives the first end. The elongated opening having a longer dimension generally circumferentially aligned along a surface of the bail support arm such that when the bail support arm is rotated between the first and second positions the compressible element forces the first end to slide along the elongated dimension of the elongated opening until the first end contacts a distal end of the elongated opening.

### FIELD OF THE INVENTION

This invention relates generally to fishing equipment and, more specifically, to open-faced spinning reels.

### BACKGROUND OF THE INVENTION

Spinning reels are very popular. They are easy to use, yet offer capabilities that appeal to even experienced users. A review of certain aspects of prior-art spinning reels will help to fully understand the present invention.

FIG. 1 is a side elevational view of a typical spinning reel 100 in a line retrieval mode. The reel 100 is coupled to an underside of a spinning rod (not shown) by a support 102 that is secured to the rod (not shown) at a mount 104. The reel 100 supports a spool 106 of fishing line (not shown) at the front 108 of the reel 100, facing a direction in which the user is fishing. A spooling mechanism (not shown) in the base 110 of the reel 100 is actuated by a crank 112 turned by the user. In FIG. 1, the crank 112 is disposed on an opposing side of the reel 100. The user turning the crank 112 causes a rotating housing or rotor 114 to revolve about an axis 116 extending nearly parallel to the rod. The reel 100, the support 102, and the mount 104 are configured such that the axis 116 is canted approximately three degrees to six degrees toward an axis of the rod to direct the spool 106 toward a first line guide (not shown) on the rod. The revolving of the rotor 114 causes a bail 120 mounted on the rotor 114 to wind the line onto the spool 106, thereby retrieving the line.

With the reel 100 in a retrieval mode as shown in FIG. 1, the bail 120 is in a closed position over the spool 106. The line extends forward toward the front 108 of the reel 100 and the rod. In retrieval mode, when the user turns the crank 112, the rotor 114 turns and causes the bail 120 to hook over the line. Tension in the line between the spool 106 and a free end of the line (not shown) draws the line toward the central axis 116 of the spool 106 where the line is hooked under a channeled line guide 122 which guides the line onto the spool 106. The spooling mechanism in the base 110 of the reel not only causes the rotor 114 to revolve, but also causes the spool 106 to reciprocate back and forth along the axis 116. As a result, the line is wound around the spool 106 and the line is evenly coiled along a length of the spool 106 along the axis 116.

FIG. 2 is a side-elevational view of a typical spinning reel 100 in a casting mode. In casting mode, the bail 120 is moved into an open bail position. With the bail 120 in an open position, the bail 120 does not contact or impede the line. As a result, line can unwind freely from the spool 106. Free movement of the line is desired when the user flicks the rod to launch a lure or baited hook toward a desired target.

Using a spinning reel 100, a user manually rotates the bail 120 to the open position (FIG. 2) prior to casting. Then, when the user begins turning the crank 112, an uncocking mechanism (not shown) drives the bail 120 to a closed position (FIG. 1) to secure the line to initiate retrieval. When the bail 120 is in either the closed position (FIG. 1) or the open position (FIG. 2), it is desired that the bail 120 remain in the intended position. If the bail 120 slips out of the open position during casting, the line would stop abruptly, potentially causing one or more barbed fishing hooks to snap backward toward the user or others nearby. On the other hand, if the bail 120 should slip out of the closed position into an open position during retrieval mode, a fish and/or a lure could be lost as the line flies unimpeded off the spool.

To maintain the bail in a desired position, a bail securing mechanism 150 (FIGS. 1 and 2) is used to apply a securing force to the bail 120 to keep the bail 120 in one of a closed or an open position. The bail securing mechanism 150 includes a plunger 152 rotatably mounted at a base end 154 and a engaging end 156 engaging a rotatable joint 158 of a bail support arm 160. The plunger 152 exerts an expansive, linear compression at the engaging end 156 opposed by a reactive force at the base end 154. As a result, when the bail 120 is in either a closed position (FIG. 1) or an open position (FIG. 2), the plunger 152 applies a moment to the rotatable joint 158 of the bail support arm 160 to maintain the bail 120 in its current position. When the user rotates the bail 120 into the open position (FIG. 2), the user must apply enough force to the bail 120 and/or the bail support arm 160 to overcome the moment applied by the plunger 152. Similarly, when the user begins turning the crank 112, the uncocking mechanism (not shown) must apply enough force to overcome the moment applied by the plunger 152.

FIG. 3A is a close-up view of the bail securing mechanism 150 of the spinning reel 100 in the closed bail position (FIG. 1) showing a cutaway view of the plunger 152. The plunger 152 includes a rod 162 slidably received in an annular cylinder 166. The rod 162 extends from its base end 154 to a received end 164. The rod 162 slides within an inner chamber 168 of the cylinder 166. The inner chamber 168 receives a compressible member 170 between the received end 164 of the rod 162 and a closed end 172 of the inner chamber 168. The compressible member 170 can be a spring or similar resilient, compressible element. Pressure generated by the compressible element 170 against the received end 164 of the rod 162 and the closed end 172 of the inner chamber 168 of the cylinder 166 generates an expansive linear force which results in the moment applied by the plunger 152 against the rotatable joint 158 of the bail support arm 160. The plunger 152 may be rotatably joined at the engaging end 156 with the rotatable joint 158 with a ball-and-socket coupling 174, or the engaging end 156 may be shaped to engage a shaped opening in the rotatable joint 158.

FIG. 3B is a perspective view of a surface 180 of the rotatable joint 154 of the bail support arm 160 in the closed bail position (FIG. 1). The surface 180 includes a circular opening 190 configured to receive the engaging end 156 of the plunger 152. Because the engaging end 156 of the plunger 152 is received in the circular opening 190, the plunger 152 is rotated around its base end 154 to track rotation of the rotatable joint 158.

The plunger 152 is coupled at the engaging end 156 to the circular opening 190 in the surface 180 of the rotatable joint 158. The plunger 152 is rotated to apply a moment to the rotatable joint 158. The moment is directed to securing the bail support arm 160 in the closed bail position.

For comparison, FIG. 4A is a close-up view of the bail securing mechanism 150 of the spinning reel 100 in the open bail position (FIG. 2) and FIG. 4B is a perspective view of a surface 180 of the rotatable joint 154 of the bail support arm 160 in the open bail position (FIG. 2). The plunger 152 is coupled at the engaging end 156 to the circular opening 190 in the surface 180 of the rotatable joint 158. The plunger 152 is rotated to apply a moment to the rotatable joint 158. In the case of FIGS. 4A and 4B, the moment is directed to securing the bail support arm 160 in the open bail position.

FIG. 4B is a perspective view of a surface 180 of the rotatable joint 154 of the bail support arm 160 in the open bail position (FIG. 2). As the rotatable joint 158 is rotated into an open bail position, the circular opening 190 rotates so that the plunger 152 applies a moment opposite of that applied when the rotatable joint 158 is in the closed bail position (FIGS. 3A and 3B).

FIG. 5 is a sequential view of five positions of the plunger 152 mechanism of the bail securing mechanism 150 as the rotatable joint 158 is rotated in a counterclockwise direction from an open bail position 510 to a closed bail position 550. The five positions shown are representative of the positions of the plunger 152 and rotatable joint 158 which rotates in a continuous motion through an arc between the open bail position 510 and the closed bail position 550.

In the open bail position 510, the plunger 152 is in a relatively extended position, with the distal end 156 of the plunger 152 applying a moment at the circular opening 190 of the rotatable joint 158 to maintain the rotatable joint 158 in the open bail position. 510. With the plunger 152 fully extended in the open bail position 510, the plunger 152 exerts its force where the position of the circular opening 190 results in a maximum moment arm 570 in the bail securing mechanism 150 shown. As the user rotates the crank 112 (FIGS. 1 and 2) to initiate retrieval of the line, the uncocking mechanism (not shown) causes the rotatable joint 158 to rotate toward the closed bail position 550, applying a force sufficient to overcome the moment applied by the plunger 152.

As the rotatable joint 158 rotates to a first intermediate position 520, the plunger 152 is compressed, pressing the cylinder 166 along the slidable rod 162 toward the base end 154 of the plunger 152. Compression of the plunger 152 compresses the compressible element 170. The rotatable joint 158 is further rotated into a second intermediate, over-center position 530. At the over-center position 530, the plunger 152 and, in turn, the compressible element 170 are at their maximum compression, thereby resulting in a greatest degree of force being applied by the plunger 152 at the circular opening 190.

Once the rotatable joint 158 has rotated through the over-center position 530 to a fourth intermediate position 540, the plunger 152 and the compressible element 170 extends to drive the rotatable element 158 toward its next position. Finally, at the closed bail position 550, the plunger 152 returns to maximum extension to apply a moment at the circular opening 190 to maintain the rotatable joint in the closed bail position 550. As in the case of the open bail position 510, the plunger 152 again applies a moment at the circular opening 190 where the circular opening 190 is positioned to result in the greatest possible moment arm.

Unfortunately, where the plunger 152 exerts the greatest possible force on the circular opening 190 at the over-center position 530, force generated by the plunger 152 results in no moment applied to the rotatable joint 158 because the force is applied with no moment arm, and instead is axially applied toward a center 500 of the rotatable joint 158. Similarly, at the first intermediate position 520 and the fourth intermediate position 540, the position of the circular opening 190 results in a shortened moment arm 570 receiving the force generated by the plunger 152. Thus, even though the force applied by the plunger 152 is greater at the first intermediate point 520 and the fourth intermediate point 540, the moment generated is undermined by the shortened moment arm 580.

As previously described, maintaining the rotatable joint 158 in its intended position is important to avoid mishaps while casting and to avoid losing fish. For these reasons, it is also important to be sure that the rotatable joint 158 reaches the open bail position 510 and the closed bail position 550. Thus, it is desirable to that the movement of the bail 120 (FIGS. 1 and 2) in the open bail position 510 and closed bail position 550 be secured as strongly as possible.

In addition, it would be desirable for the bail 120 to provide audible feedback to the user that the bail 120 has reached the desired position. With audible feedback, the user would not have to take his or her eyes away from where he or she is fishing. Thus, audible feedback would allow the user to concentrate on watching the casting target or in watching the tip of the pole for movement indicating a strike. Ideally, such feedback would be provided without having to include a separate mechanism solely for the purpose of generating audible feedback. A separate mechanism would increase the complexity and manufacturing costs of the reel.

Thus, there is an unmet need in the art for a bail securing mechanism capable of improving the forcefulness with which the bail securing mechanism secures the bail in place. There is also an unmet need for a bail securing mechanism capable of providing audible feedback confirming that the bail has reached either the open bail position or the closed bail position.

### SUMMARY OF THE INVENTION

The present invention provides a bail securing apparatus and a fishing reel using the apparatus. By providing an elongated slidable opening in a bail support arm for receiving a compressible plunger, embodiments of the present invention increase a moment arm by which the plunger applies a securing moment to the bail support arm. In addition, embodiments of the present invention generate a sound, such as a latching, snapping, or clicking sound, to provide audible feedback signaling when the rotatable bail being is secured an open bail position or a closed bail position.

More particularly, embodiments of the present invention include a bail securing apparatus for use with a fishing reel such as a spinning reel. A plunger includes a first end and a second end. The first end applies a securing force against a bail support arm supporting a first end of the bail. The first end is slidably coupled with the second end by a compressible element configured to force the first end away from the second end. A plunger mount swivelably receives the second end. An elongated opening in the bail support arm receives the first end. The elongated opening has a longer dimension generally circumferentially aligned along a surface of the bail support arm such that when the bail support arm is rotated from a first position to a second position the compressible element forces the first end to slide along the longer dimension of the elongated opening until the first end contacts a distal end of the elongated opening.

In accordance with further aspects of the invention, the compressible element driving the plunger includes a spring. Further, the plunger includes a housing that has a receiving end and an opposing end. The receiving end is configured to receive the compressible element. Also, the housing includes an inner sleeve including a closed end and an open end. The open end is configured to receive the compressible element. The compressible element is configured to compressibly receive a first end of slidable rod to compress the compressible element between the closed end of the housing and the first end of the slidable rod. The closed end of the housing includes the engaging end of the plunger and a second end of the slidable rod includes the second end of the plunger.

In accordance with other aspects of the present invention, the elongated opening includes a generally elliptical shape or a generally rectangular shape. The elongated opening includes a trailing end configured to guide the engaging end of the plunger past an over-center position. The trailing end is disposed such that, after the engaging end is led through the over-center position the engaging end of the plunger slides along the elongated dimension of the elongated opening until the engaging end contacts the distal end of the elongated opening. The elongated opening includes a striking surface for forcibly receiving the engaging end such that a sound is made when the engaging end reaches the distal end.

In accordance with still further embodiments of the present invention, the elongated opening includes an outward-facing channel disposed on an outer surface of the bail support arm. Also, the elongated opening includes a restraining track configured to slidably secure the engaging end of the plunger such that the engaging end is constrained to slide between the trailing end of the elongated opening and the distal end of the elongated opening. The restraining track, for one example, includes a circumferentially disposed ball groove and the engaging end includes a ball joint configured to engage the ball groove.

### BRIEF DESCRIPTION OF THE DRAWINGS

The preferred and alternative embodiments of the present invention are described in detail below with reference to the following drawings.

FIG. 1 is a side-elevational view of a conventional spinning reel in a closed bail, retrieval position;

FIG. 2 is a side-elevational view of a conventional spinning reel in an open bail, casting position;

FIG. 3A is a close-up view of a bail securing mechanism of the spinning reel of FIG. 1 including a cutaway view of a plunger used in the bail securing mechanism;

FIG. 3B is a perspective view of a surface of a bail support arm of the spinning reel of FIG. 1;

FIG. 4A is a close-up view of a bail securing mechanism of the spinning reel of FIG. 2;

FIG. 4B is a perspective view of a surface of a bail support arm of the spinning reel of FIG. 2;

FIG. 5 is a perspective view of positions of a plunger mechanism of the bail securing mechanism of the spinning reel of FIGS. 3A-4B;

FIG. 6A is a close-up view of a bail securing mechanism in a closed bail position according to an embodiment of the present invention;

FIG. 6B is a perspective view of a surface of a bail support arm of a spinning reel in a closed bail position according to an embodiment of the present invention;

FIG. 7A is a close-up view of a bail securing mechanism in an open bail position according to an embodiment of the present invention;

FIG. 7B is a perspective view of a surface of a bail support arm of a spinning reel in an open bail position according to an embodiment of the present invention; and

FIG. 8 is a perspective view of positions of a plunger mechanism of the bail securing mechanism of FIGS. 6A-7B.

### DETAILED DESCRIPTION OF THE INVENTION

By way of overview, embodiments of the present invention include a bail securing apparatus for use with a fishing reel such as a spinning reel. A plunger includes a first end and a second end. The first end applies a securing force against a bail support arm supporting a first end of the bail. The first end is slidably coupled with the second end by a compressible element configured to force the first end away from the second end. A plunger mount swivelably receives the second end. An elongated opening in the bail support arm receives the first end. The elongated opening has a longer dimension generally circumferentially aligned along a surface of the bail support arm such that when the bail support arm is rotated from a first position to a second position the compressible element forces the first end to slide along the longer dimension of the elongated opening until the first end contacts a distal end of the elongated opening.

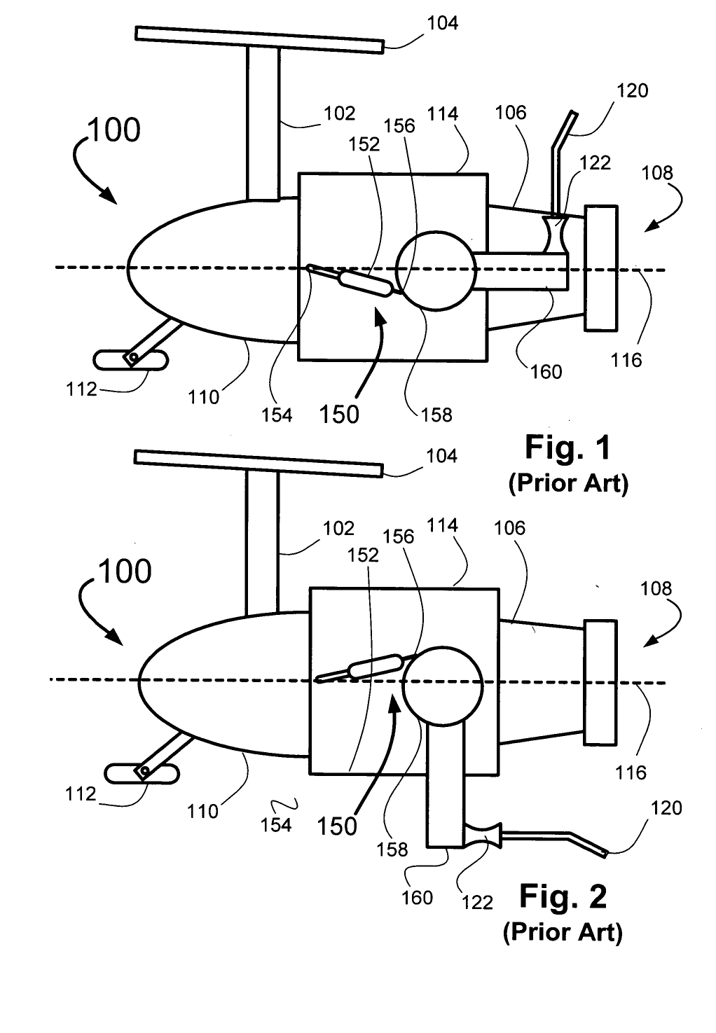

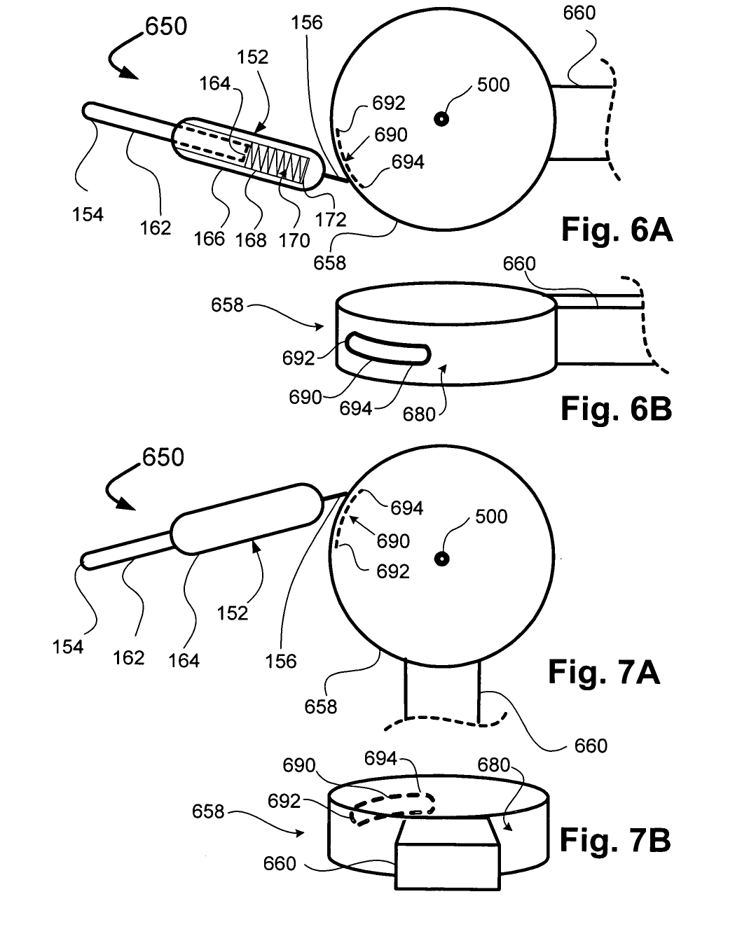

FIG. 6A shows a close-up view of the bail securing mechanism 650 of the spinning reel 100 in the open bail position (FIG. 2) according to an embodiment of the present invention. The bail securing mechanism 650, in one presently preferred embodiment, is incorporated in a spinning reel such as the spinning reel 100 shown in FIGS. 1 and 2. A bail securing arm 660 supports an end of a bail 120 (FIGS. 1 and 2). The bail securing mechanism 650 includes a rotatable joint 658. The bail securing mechanism 650 includes a plunger 152 rotatably mounted at a base end 154 and an engaging end 156 engaging a rotatable joint 158 of a bail support arm 160 in an elongated opening (not shown). The plunger 152 exerts an expansive, linear compression at the engaging end 156 opposed by a reactive force at the base end 154. The plunger 152 includes a rod 162 slidably received in an annular cylinder 166. The rod 162 extends from its base end 154 to a received end 164. The rod 162 slides within an inner chamber 168 of the cylinder 166. The inner chamber 168 receives a compressible member 170 between the received end 164 of the rod 162 and a closed end 172 of the inner chamber 168. The compressible member 170 can be a spring or similar resilient, compressible element. Pressure generated by the compressible element 170 against the received end 164 of the rod 162 and the closed end 172 of the inner chamber 168 of the cylinder 166 generates a linear force which results in the moment applied by the plunger 152 against the rotatable joint 158 of the bail support arm 160.

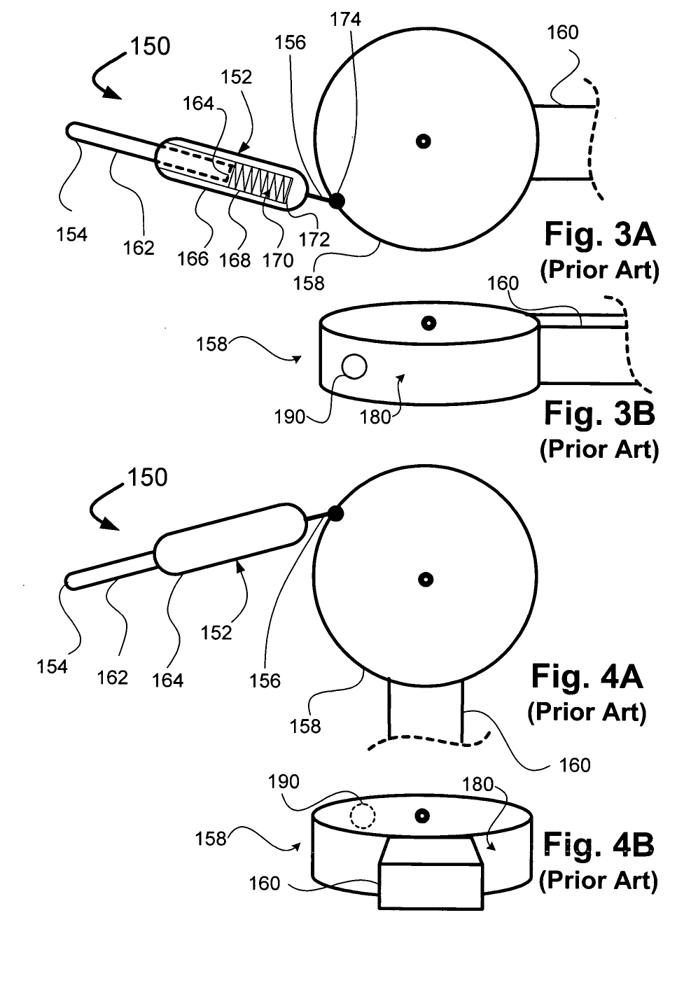

As in the bail securing system 150 (FIGS. 3A-4B), when the bail 120 is in either a closed position (FIG. 1) or an open position (FIG. 2), the plunger 152 applies a moment to the rotatable joint 658 about its center 500 to maintain the bail 120 in its current position. However, by contrast to the bail securing system 150, the bail securing system 650 is configured to allow the plunger 152 to extend to apply its extensive force to a greatest possible moment arm. The engaging end 156 of the plunger is received in an elongated opening 690 instead of a circular opening 190 (FIGS. 3A-4B). The elongated opening 690 has a trailing end 692 for guiding the engaging end 156 past an over-center position when the rotatable joint 658 is rotated between the closed bail position and the open bail position. The elongated opening 690 allows the engaging end 156 of the plunger 152 to slide toward a distal end 694 of the elongated opening 690. The sliding of the engaging end 156 toward the distal end 694 improves the functioning of the bail securing mechanism 650 as will be further described below.

FIG. 6B is a perspective view of a surface 680 of the rotatable joint 658 of the bail support arm 660 in the closed bail position. FIG. 6B shows the elongated opening 690 that receives the engaging end 156 of the plunger 152 according to an embodiment of the present invention. In one presently preferred embodiment, the elongated opening 690 is generally elliptical in shape, as shown in FIG. 6B. Alternatively, the elongated opening 690 could have a rectangular shape or another elongated shape. The elongated opening 690 slidably receives the engaging end 156 of the plunger. Thus, unlike the circular opening 190 (FIGS. 3A-4B), the engaging end 156 is not constrained to apply its moment at a moment arm perpendicularly projected from the circular opening 190 toward the center 500 of the rotatable joint 658. The elongated opening 690 includes the trailing end 692 and the distal end 694. The trailing end 694 directs the engaging end 156 past the over-center position when the rotatable joint 658 is rotated between the open and closed bail positions. Once the trailing end 692 draws the engaging end 156 past the over-center position, the elongated opening 690 allows the engaging end 156 to slide until it contacts the distal end 692.

FIG. 7A is a close-up view of the bail securing mechanism 650 of the spinning reel 100 in the open bail position (FIG. 2). The plunger 152 is received at the engaging end 156 by the elongated opening 690 in the surface 680 of the rotatable joint 158. The plunger 152 is rotated to apply a moment to the rotatable joint 158. In the case of FIGS. 7A and 7B, the moment is directed to securing the bail support arm 160 in the open bail position.

FIG. 7B is a perspective view of a surface 680 of the rotatable joint 658 of the bail support arm 660 in the open bail position (FIG. 2). As the rotatable joint 658 is rotated into an open bail position, the elongated opening 690 rotates so that the plunger 152 applies a moment opposite of that applied when the rotatable joint 658 is in the closed bail position. As the rotatable joint 658 is rotated between the open bail position and the closed bail position, the trailing end 692 and the distal end 694 of the elongated opening 690 effectively switch places. What previously was the distal end 694 rotates back to engage the engaging end 156 of the plunger 152, where it becomes the trailing end 692 to guide the engaging end 156 through the over-center position. Once the new trailing end 692 guides the engaging end 156 through the over-center position, the engaging end 156 slides through the elongated opening 690 toward the new distal end 694. Past the over-center position, the plunger 152 rapidly extends to lengthen the moment arm the plunger 152 applies to the rotatable joint 658.

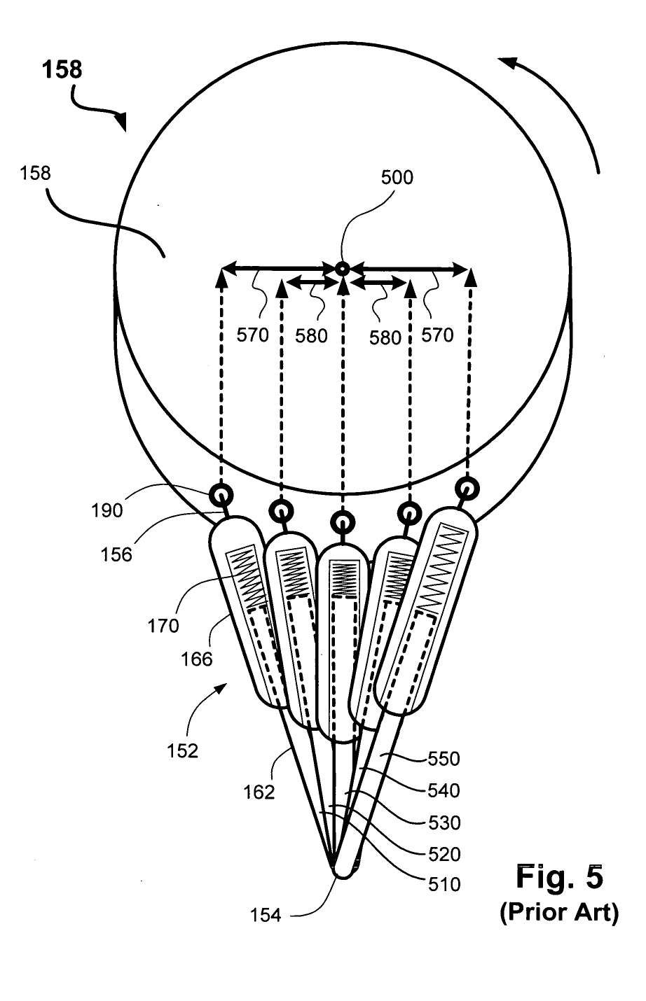

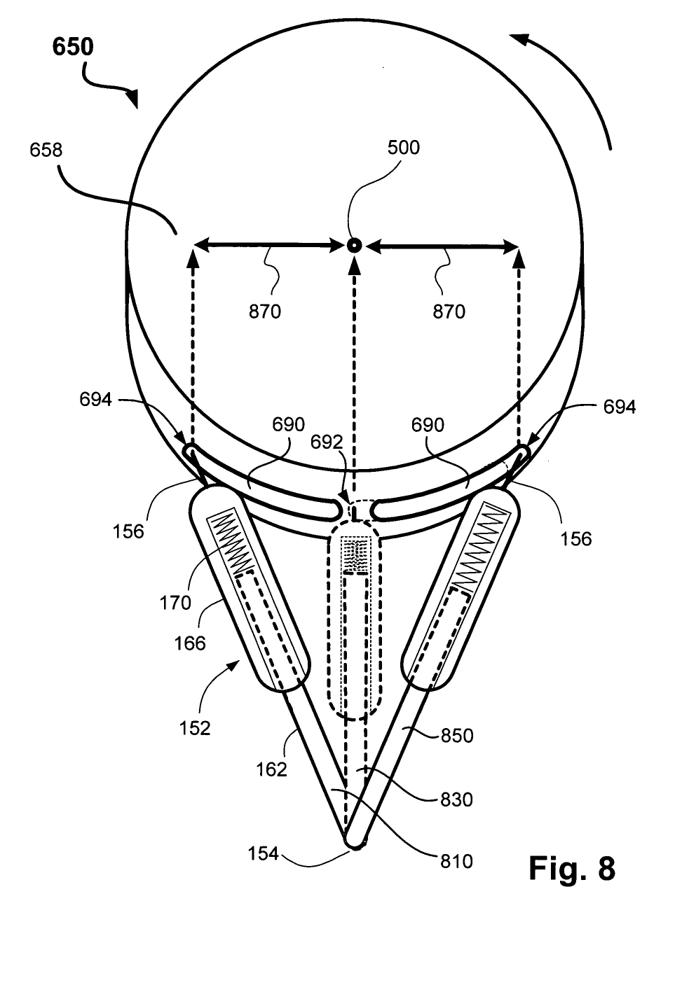

FIG. 8 shows a sequential view of three positions of the plunger 152 mechanism of the bail securing mechanism 650 as the rotatable joint 658 is rotated in a counterclockwise direction from an open bail position 810 to a closed bail position 850. The three positions shown are representative of the positions of the plunger 152 and the rotatable joint 658. However, unlike the bail securing mechanism 150 (FIG. 5), the bail securing system 650 according to an embodiment of the present invention is not rotated in a continuous motion through an arc between the open bail position 510 and the closed bail position 550. Instead, once the engaging end 156 of the plunger 152 passes the over-center position, the plunger 152 snaps to an extended position.

In the open bail position 810, the plunger 152 is in an extended position, with the engaging end 156 of the plunger 152 applying a moment at the elongated opening 690 of the rotatable joint 658 to maintain the rotatable joint 658 in the open bail position 810. With the plunger 152 fully extended in the open bail position 810, the plunger 152 exerts its force where the position of the elongated opening 690 results in a maximum moment arm 870. As the user rotates the crank 112 (FIGS. 1 and 2) to initiate retrieval of the line, the uncocking mechanism (not shown) causes the rotatable joint 658 to rotate toward the closed bail position 850, applying a force sufficient to overcome the moment applied by the plunger 152.

As the rotatable joint 658 rotates toward the closed bail position 850, at an over-center position 830 what previously had been the distal end 694 of the elongated opening 690 becomes the trailing end 692. The trailing end 692 guides the engaging end through the over-center position 830 causing the plunger 152 to be compressed. The trailing end 692 pulling the engaging end 156 of the plunger 152 presses the cylinder 166 along the slidable rod 162 toward the base end 154 of the plunger 152. Compression of the plunger 152 compresses the compressible element 170. At the over-center position 830, the plunger 152 and, in turn, the compressible element 170 are at their maximum compression, thereby resulting in a greatest degree of force being applied by the plunger 152 at the elongated opening 690. As previously described, in a conventional bail securing mechanism 150 (FIGS. 1-5), the force potentially generated by the maximum compression of the plunger 152 and the compressible element 170 previously were underutilized by the short moment arms of the conventional bail securing mechanism 150. However, using the bail securing mechanism 650 according to an embodiment of the present invention, once the plunger 152 has been guided past the over-center position 830 by the trailing end 692, the engaging end 156 of the plunger 152 slides to the new distal end 694 of the elongated opening 690. Release of the energy of the compressible element 170 presses against a longer moment arm 870 than would be possible if the engaging end 156 were locked into the circular opening 190.

Use of the elongated opening 690 according to an embodiment of the present invention provides at least two advantages. First, as described, the elongated opening 690 allows the plunger 152 to apply its force to a longer moment arm 870 to provide a greater or more quickly applied securing force to the rotatable joint 658. As a result, the securing of the bail 120 (FIGS. 1 and 2) is more readily achieved. Second, the sliding of the engaging end 156 of the plunger 152 to the distal end 694 of the elongated groove 690 after the engaging end 156 passes through the over-center position results in the engaging end 156 striking the distal end 694 with a percussive impact. As a result, the engaging end 156 striking the distal end 694 makes a clicking or snapping sound. The sound provides audible feedback to a user that the bail 120 has been moved into the open bail position or the closed bail position. Thus, the user can be sure that the bail 120 is in a desired position without having to take his or her eyes off the task at hand.

The elongated opening 690 can be shaped to contain the movement of the engaging end 156 to prevent the engaging end 156 from slipping out of the elongated opening 690. Alternatively, the engaging end 156 of the plunger 152 could be fitted with a ball joint and the elongated opening 690 could be fitted with a slidable socket to secure the ball joint in the elongated opening 690. Also alternatively, the engaging end 156 could be fitted with another coupling that could be slidably secured in the elongated opening 690. Also, materials used for the engaging end 156 and a lining of the elongated opening 690 of the rotatable joint 658 suitably are selected according to their hardness or other properties for optimizing the loudness of the sound that will result from the engaging end 156 striking the distal end 694 of the elongated opening 690.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. An apparatus for securing a position of a bail on a fishing reel in each of a first bail position and a second bail position by applying a securing force against a bail support arm supporting a first end of the bail, the apparatus comprising:
a plunger having a first end and a second end, the first end being slidably coupled with the second end by a compressible element configured to force the first end away from the second end;
a plunger mount swivelably receiving the second end of the plunger; and
an elongated opening in the bail support arm for receiving the first end of the plunger, the elongated opening having its longer dimension generally circumferentially aligned along a surface of the bail support arm such that when the bail support arm is rotated from the first bail position to the second bail position the compressible element forces the first end to slide along the longer dimension of the elongated opening until the first end contacts a distal end of the elongated opening.

2. The apparatus of claim 1, wherein the compressible element includes a spring.

3. The apparatus of claim 1, wherein the plunger includes a housing having a receiving end and an opposing end, the receiving end being configured to receive the compressible element, and a first end of slidable rod to compress the compressible element between the closed end of the housing and the first end of the slidable rod.

4. The apparatus of claim 1, wherein the elongated opening is generally elliptical in shape.

5. The apparatus of claim 1, wherein the elongated opening is generally rectangular in shape.

6. The apparatus of claim 1, wherein the elongated opening includes a trailing end configured to guide the first end of the plunger past an over-center position such that once the first end passes through the over-center position the first end of the plunger slides along the elongated dimension of the elongated opening until the first end contacts the distal end of the elongated opening.

7. The apparatus of claim 1, wherein the elongated opening includes an outward-facing channel disposed on an outer surface of the bail support arm, the outer surface of the bail support arm being generally parallel with a rotation axis of the bail support arm.

8. The apparatus of claim 1, wherein the elongated opening includes a restraining device configured to slidably restrain the first end of the plunger to slide between the trailing end of the elongated opening and the distal end of the elongated opening.

9. An apparatus for securing a position of a bail on a fishing reel in each of a first bail position and a second bail position by applying a securing force against a bail support arm supporting a first end of the bail, the apparatus comprising:
a plunger having a first end and a second end, the first end being slidably coupled with the second end by a compressible element configured to force the first end away from the second end;
a plunger mount swivelably receiving the second end of the plunger; and
a receiving orifice in the bail support arm for receiving the first end of the plunger, the receiving orifice including:
an elongated opening with a longer dimension generally circumferentially aligned along a surface of the bail support arm;
a trailing end of the elongated opening configured to guide the first end of the plunger past an over-center position as the bail support arm is rotated between the first position and the second position such that the compressible element forces the first end of the plunger to slide along the longer dimension of the elongated opening away from the trailing end; and
a distal end of the elongated opening configured to receive the first end of the plunger and generate a sound when the first end reaches the distal end.

10. The apparatus of claim 9, wherein the compressible element includes a spring.

11. The apparatus of claim 9, wherein the plunger includes a housing having a receiving end and an opposing end, the receiving end being configured to receive the compressible element and a first end of slidable rod to compress the compressible element between the closed end of the housing and the first end of the slidable rod such that sliding the slidable rod into the housing results in the plunger generating a linear compression between the opposing end of the housing and a second end of the slidable rod.

12. The apparatus of claim 9, wherein the elongated opening is generally elliptical in shape.

13. The apparatus of claim 9, wherein the elongated opening is generally rectangular in shape.

14. The apparatus of claim 9, wherein the elongated opening includes an outward-facing channel disposed on an outer surface of the bail support arm, the outer surface of the bail support arm being generally parallel with a rotation axis of the bail support arm.

15. The apparatus of claim 9, wherein the elongated opening includes a restraining device configured to slidably restrain the first end of the plunger to slide between the trailing end of the elongated opening and the distal end of the elongated opening.

16. A spinning reel fishing apparatus, the apparatus including:
a support configured to mount the apparatus on a pole;
a line spool configured to receive a length of fishing line wrapped around a surface of the spool, the surface of the spool being parallel to a spool axis;
a bail including:
a line guide configured to guide fishing line onto the line spool;
a bail arm configured to capture the fishing line and guide it toward the line guide;
a bail securing apparatus for securing a position of the bail by applying a securing force against a bail support arm supporting a first end of the bail, the bail securing apparatus including:
a plunger having a first end and a second end, the first end being slidably coupled with the second end by a compressible element configured to force the first end away from the second end;
a plunger mount swivelably receiving the second end of the plunger; and
an elongated opening in the bail support arm for receiving the first end of the plunger, the elongated opening having a longer dimension generally circumferentially aligned along a surface of the bail support arm such that when the bail support arm is rotated from the first bail position to the second bail position the compressible element forces the first end to slide along the elongated dimension of the elongated opening until the first end contacts a distal end of the elongated opening; and
a rotatable housing rotatably supporting the bail, the rotatable housing being configured to rotate the bail around the spool axis and wind the fishing line onto the spool; and
a spooling mechanism coupled with the rotatable housing and a crank such that when an operator turns the crank the spooling mechanism causes the rotatable housing to rotate about the spool axis of the spool.

17. The apparatus of claim 16, wherein the compressible element includes a spring.

18. The apparatus of claim 16, wherein the plunger includes a housing having a receiving end and an opposing end, the receiving end being configured to receive the compressible element and a first end of slidable rod to compress the compressible element between the closed end of the housing and the first end of the slidable rod such that sliding the slidable rod into the housing results in the plunger generating a linear compression between the opposing end of the housing and a second end of the slidable rod.

19. The apparatus of claim 16, wherein the elongated opening is generally elliptical in shape.

20. The apparatus of claim 16, wherein the elongated opening is generally rectangular in shape.

21. The apparatus of claim 16, wherein the elongated opening includes a trailing end configured to guide the first end of the plunger past an over-center position such that once the first end passes through the over-center position the first end of the plunger slides along the elongated dimension of the elongated opening until the first end contacts the distal end of the elongated opening.

22. The apparatus of claim 16, wherein the elongated opening includes an outward-facing channel disposed on an outer surface of the bail support arm, the outer surface of the bail support arm being generally parallel with a rotation axis of the bail support arm.

23. The apparatus of claim 16, wherein the elongated opening includes a restraining device configured to slidably restrain the first end of the plunger to slide between the trailing end of the elongated opening and the distal end of the elongated opening.

24. A spinning reel fishing apparatus, the apparatus including:
a support configured to mount the apparatus on a pole;
a line spool configured to receive a length of fishing line wrapped around a surface of the spool, the surface of the spool being parallel to a spool axis;
a bail including:
a line guide configured to guide fishing line onto the line spool;
a bail arm configured to capture the fishing line and guide it toward the line guide;
a bail securing apparatus for securing a position of the bail by applying a securing force against a bail support arm supporting a first end of the bail, the bail securing apparatus including:
a plunger having a first end and a second end, the first end being slidably coupled with the second end by a compressible element configured to force the first end away from the second end;
a plunger mount swivelably receiving the second end of the plunger; and
a receiving orifice in the bail support arm for receiving the first end of the plunger, the receiving orifice including:
an elongated opening with an elongated dimension generally circumferentially aligned along a surface of the bail support arm;
a trailing end of the elongated opening configured to guide the first end of the plunger past an over-center position as the bail support arm is rotated between the first position and the second position such that the compressible element forces the first end of the plunger to slide along the elongated dimension of the elongated opening away from the trailing end; and
a distal end of the elongated opening configured to receive the first end of the plunger and generate a sound when the first end reaches the distal end; and
a rotatable housing rotatably supporting the bail, the rotatable housing being configured to rotate the bail around the spool axis and wind the fishing line onto the spool; and
a spooling mechanism coupled with the rotatable housing and a crank such that when an operator turns the crank the spooling mechanism causes the rotatable housing to rotate about the spool axis of the spool.

25. The apparatus of claim 24, wherein the compressible element includes a spring.

26. The apparatus of claim 24, wherein the plunger includes a housing having a receiving end and an opposing end, the receiving end being configured to receive the compressible element and a first end of slidable rod to compress the compressible element between the closed end of the housing and the first end of the slidable rod such that sliding the slidable rod into the housing results in the plunger generating a linear compression between the opposing end of the housing and a second end of the slidable rod.

27. The apparatus of claim 24, wherein the elongated opening is generally elliptical in shape.

28. The apparatus of claim 24, wherein the elongated opening is generally rectangular in shape.

29. The apparatus of claim 24, wherein the elongated opening includes an outward-facing channel disposed on an outer surface of the bail support arm, the outer surface of the bail support arm being generally parallel with a rotation axis of the bail support arm.

30. The apparatus of claim 24, wherein the elongated opening includes a restraining device configured to slidably restrain the first end of the plunger to slide between the trailing end of the elongated opening and the distal end of the elongated opening.
